(19) United States
(12) Patent Application Publication
(10) Pub. No.: US 2021/0091628 A1
(43) Pub. Date: Mar. 25, 2021

(54) LUBRICANT SUPPORTED ELECTRIC MOTOR WITH A PROFILED RACEWAY

(71) Applicant: Neapco Intellectual Property Holdings, LLC, Farmington Hills, MI (US)

(72) Inventors: Donald Remboski, Ann Arbor, MI (US); Jacqueline Dedo, Wolverine Lake, MI (US); Mark Versteyhe, Oostkamp (BE)

(21) Appl. No.: 17/030,818

(22) Filed: Sep. 24, 2020

Related U.S. Application Data
(60) Provisional application No. 62/905,481, filed on Sep. 25, 2019.

(51) Int. Cl. H02K 5/24; F16N 1/00; F16N 7/36; H02K 7/00

(52) U.S. Cl. CPC H02K 5/24; F16N 1/00; B60K 7/0007; H02K 7/006; F16N 7/36

(57) ABSTRACT

A lubricant supported electric motor includes a stator presenting an outer raceway and a rotor extending along an axis and rotatably disposed within the stator to present an inner raceway disposed in spaced relationship with said the raceway to define a gap therebetween. A lubricant is disposed in the gap for supporting the rotor within the stator. At least one of the outer raceway or the inner raceway are profiled with a non-circular, cross-sectional shape for maintaining consistent support of the rotor over a wide range of operating speeds and dynamic situations encountered by the lubricant supported electric motor during operation.

### CROSS-REFERENCE TO RELATED APPLICATION

The subject application claims priority to U.S. Provisional Application Ser. No. 62/738,165 filed on Sep. 25, 2019, the entire disclosure of which is incorporated herein by reference

### FIELD OF THE DISCLOSURE

The present disclosure relates generally to a lubricant supported electric motor. More specifically, the present disclosure relates to a lubricant supported electric motor including a profiled raceway.

### BACKGROUND OF THE INVENTION

This section provides a general summary of background information and the comments and examples provided in this section are not necessarily prior art to the present disclosure.

Various drivelines in automotive, truck, and certain off-highway applications take power from a central prime mover and distribute the power to the wheels using mechanical devices such as transmissions, transaxles, propeller shafts, and live axles. These configurations work well when the prime mover can be bulky or heavy, such as, for example, various internal combustion engines (“ICE”). However, more attention is being directed towards alternative arrangements of prime movers that provide improved environmental performance, eliminate mechanical driveline components, and result in a lighter-weight vehicle with more space for passengers and payload.

“On wheel” motor configurations are one alternative arrangement for the traditional ICE prime mover that distributes the prime mover function to each or some of the plurality of wheels via one or more motors disposed proximate to, on, or within the plurality of wheels. For example, in one instance, a traction motor, using a central shaft though a rotor and rolling element bearings to support the rotor, can be utilized as the “on wheel” motor configuration. In another instance, a lubricant supported electric motor, such as described in U.S. application Ser. No. 16/144,002, the disclosure of which is incorporated herein by reference, can be utilized as the “on wheel” motor configuration. While each of these “on wheel” motor configurations result in a smaller size and lighter weight arrangement as compared to the prime movers based on the internal combustion engine, they each have certain drawbacks and disadvantages.

For example, the utilization of traction motors as the “on wheel” configuration still results in motors that are too heavy and not robust enough to shock loading to be useful for wheel-end applications. In other words, present traction motors are large, heavy structures supported by rolling element bearings, which are too heavy and large to be practical for wheel end applications. Similarly, the utilization of a lubricant supported electric motors as a wheel-end motor in an automotive or land vehicle application results in an arrangement with some performance issues when it is subjected to the wide range of dynamic forces encountered during operation at the wide range of speeds encountered in a prime-mover application. Specifically, the wide range of speeds encountered by the lubricant supported electric motor when utilized in a wheel-end application leads to a number of dynamic effects such as: deflectional critical speeds; torsional critical speeds; torque and translational forces on the rotor related to rotor magnetic pole forces; half-speed load vectors (e.g., due to operation at a speed where the rotor mass imbalance force matches the rotor weight, due to operation where other powertrain equipment creates a ½ order vibration); rotor ½ speed whirl; as well as others. Present arrangements of lubricant supported electric motors are not robust enough to perform well under all these conditions and dynamic forces encountered in a wheel-end motor arrangement. Accordingly, there remains a need for improvements to wheel-end motors, specifically lubricant supported electric motors, which improve performance over the wide range of speeds encountered in a wheel-end prime-mover application, while also providing the lighter and smaller footprint sought from this alternative prime mover implementation.

### SUMMARY OF THE INVENTION

The subject invention is generally directed to a lubricant supported electric motor that includes a stator presenting an outer raceway, and a rotor extending along an axis and rotatably disposed within the stator to present an inner raceway disposed in spaced relationship with the outer raceway to define a gap therebetween. A lubricant is disposed in the gap for supporting the rotor within the stator. At least one of the outer raceway or the inner raceway is profiled with a non-circular, cross-sectional shape for advantageously addressing and overcoming many of the dynamic effects arising when the lubricant supported electric motor is utilized in a wheel-end application. For example, the at least one profiled raceway advantageously helps maintain consistent rotor support over a wider range of operating speeds and dynamic loading situations while maintaining parasitic losses. Thus, the lubricant supported electric motor with at least one profiled raceway provides a wheel-end motor that is more robust than the prior art “on-wheel” motor configurations, and thus is suitable for the shock loading encountered by wheel-end applications. The lubricant supported electric motor with a profiled raceway is also light and small, and thus contributes to the overall design strategy for eliminating weight and size from automobiles and land vehicles. Other advantages will be appreciated in view of the following more detailed description of the subject invention.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a lubricant supported electric motor according to an aspect of the subject disclosure;

FIG. 2 is a cross-sectional view of the lubricant supporting electric motor taken along line 2-2 of FIG. 1 illustrating a first embodiment of a non-circular cross-sectional shape of an outer raceway presented on a stator;

FIG. 3 is a cross-sectional view of the lubricant supported electric motor taken along line 3-3 of FIG. 1 illustrating a second embodiment of the non-circular cross-sectional shape of the outer raceway; and

FIG. 4 is a cross-sectional shape of the lubricant supported electric motor taken along line 4-4 of FIG. 1 illustrating a third embodiment of a non-circular cross-sectional shape of an inner raceway presented on a rotor.

### DETAILED DESCRIPTION OF THE ENABLING EMBODIMENTS

Example embodiments of a lubricant supported electric motor with at least one profiled raceway in accordance with the present disclosure will now be more fully described. Each of these example embodiments are provided so that this disclosure is thorough and fully conveys the scope of the inventive concepts, features and advantages to those skilled in the art. To this end, numerous specific details are set forth such as examples of specific components, devices and mechanisms associated with the lubricant supported electric motor to provide a thorough understanding of each of the embodiments associated with the present disclosure. However, as will be apparent to those skilled in the art, not all specific details described herein need to be employed, the example embodiments may be embodied in many different forms, and thus should not be construed or interpreted to limit the scope of the disclosure.

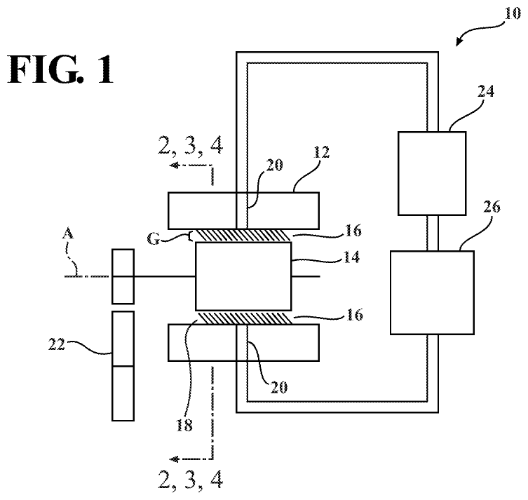

FIGS. 1-4 illustrate a lubricant supported electric motor 10 in accordance with an aspect of the disclosure. As best illustrated in FIG. 1, the lubricant supported electric motor 10 includes a stator 12 and a rotor 14 movably disposed within the stator 12 to define a gap 16 therebetween. A lubricant 18 is disposed in the gap 16 for supporting the rotor 14 within the stator 12, and providing continuous contact between these components. The lubricant 18 may therefore act as a buffer (e.g., suspension) between the stator 12 and the rotor 14 minimizing or preventing contact therebetween. In other words, the lubricant 18 prevents direct contact between the stator 12 and rotor 14 and provides an electric lubricant supported motor 10 which is robust to shock and vibration loading due to the presence of the lubricant 18. Additionally, and alternatively, a substantially incompressible lubricant 18 may be used in order to minimize the gap between the stator 12 and rotor 14.

As further illustrated FIG. 1, the stator 12 defines a passageway 20 disposed in fluid communication with the gap 16 for introducing the lubricant 18. However, the passageway 20 could be provided on any other components of the lubricant supported electric motor 10 without departing from the subject disclosure. According to an aspect, the lubricant 18 may be cycled or pumped through the passageway 20 and into the gap 16 in various ways. For example, a high pressure source (e.g., a pump) 24 of the lubricant 18 may be fluidly coupled to a low pressure source (e.g., a sump) 26 of the lubricant 18, where the lubricant 18 may move from the high pressure source 24 to the lower pressure source 26, through the passageway 20 and into the gap 16. Rotation of the rotor 14 relative to the stator 12 may operate as a self-pump to drive lubricant 18 through the passageway 20 and into the gap 16.

As further illustrated in FIG. 1, the rotor 14 is interconnected to a drive assembly 22 for coupling the lubricant supported electric motor 10 to one of the plurality of wheels of a vehicle. For example, in one instance, the drive assembly 22 may include a planetary gear system. Alternatively, the drive assembly 22 may include one or more parallel axis gears. The stator 12 and rotor 14 are configured to exert an electromagnetic force therebetween to convert electrical energy into mechanical energy, moving the rotor 14 and ultimately driving the wheel coupled to the lubricant supported electric motor 10. The drive assemblies 22 may provide one or more reduction ratios between the lubricant supported electric motor 10 and the wheel in response to movement of the rotor 14.

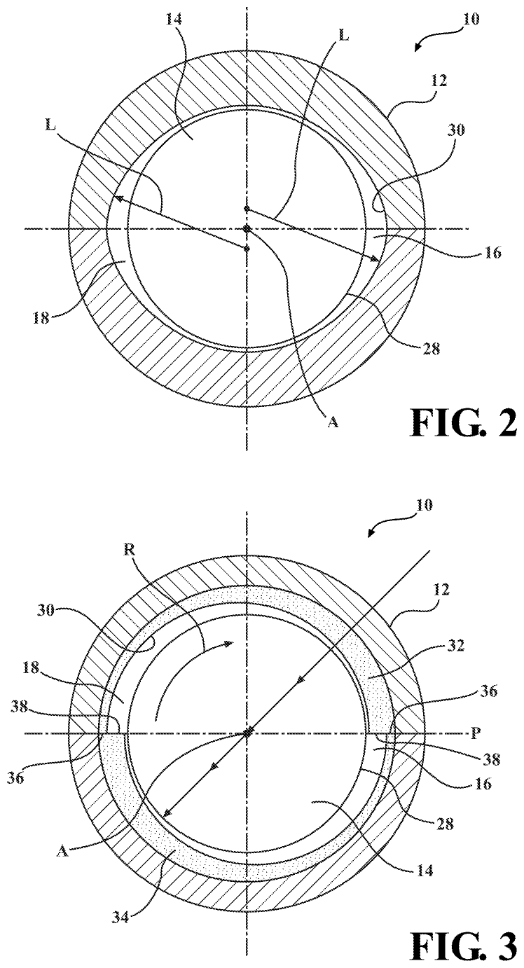

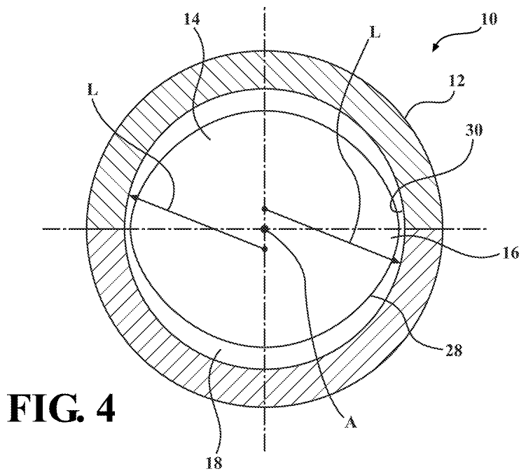

As best illustrated in FIGS. 2-4, the rotor 14 presents an inner raceway 28 and the stator 12 presents an outer raceway 30. One of the inner or outer raceways 28, 30 is profiled with a non-circular, cross-sectional shape when viewed along a plane extending perpendicularly to the axis A (See e.g., cross-sectional planes 2-2, 3-3 and 4-4 illustrated in FIG. 1) to advantageously help maintain consistent rotor support over a wide range of operating speeds and dynamic situations encountered by the lubricant supported electric motor 10 while maintaining lower parasitic losses. In other words, it has been found that incorporating a non-circular profile into either the inner raceway 28 defined by the rotor 14 or the outer raceway 30 defined by the stator 12 helps to address and overcome many of the dynamic effects arising when the lubricant supported electric motor 10 is utilized in a wheel-end application. For example, as illustrated in FIG. 2, in one arrangement the outer raceway 30 defined by the stator 12 can have an oval cross-sectional profile when viewed along a plane 2-2 extending perpendicular to the axis A (shown in FIG. 1). Alternatively, as best illustrated in FIG. 4, in an alternative embodiment, the profiled raceway arrangement can be reversed with the inner raceway 28 presented by the rotor 14 having an oval cross-sectional profile when viewed in cross-section along a plane 4-4 extending perpendicularly to the axis A (also shown in FIG. 1).

Other arrangements of a non-circular cross-sectional profile for the inner or outer raceways 28, 30 can be utilized without departing from the scope of the subject disclosure. For example, as illustrated in FIG. 3, in another arrangement the outer raceway 30 defined by the stator 12 can have an offset ramp cross-sectional profile when viewed in cross-section along a plane 3-3 extending perpendicular to the axis A (also shown in FIG. 1). More specifically, in this arrangement, the inner raceway 30 of the stator 12 includes a semi-circular top portion 32 and a semi-circular bottom portion 34 arranged opposite to one another about a plane P extending along the axis A. Each of the top and bottom portions 32, 34 extend clockwise (in a direction of rotation of the rotor, shown by arrow R) from a first end 36 to a second end 38, with the first end 36 of the top portion 32 beginning where the second end 38 of the bottom portion 34 terminates, and vice-versa for the bottom portion 34. Each of the top and bottom portions 32, 34 are ramped radially inwardly along the direction of rotation of the rotor R from the first end 36 to the second end 38, such that a thinnest cross-section of the semi-circular top and bottom portions 32, 34 is disposed adjacent the first ends 36 and a thickest cross-section of the semi-circular top and bottom portions 32, 34 is disposed adjacent the second ends 38.

With further reference to FIGS. 2 and 4, the arrows L indicate the direction of maximum load carrying capacity when the rotor 14 is rotating in a clockwise direction. For example, in a wheel-end motor, this characteristic can be used to maximize bearing capacity in a direction of expected shock loading due to suspension movement. With further reference to FIG. 3, the offset ramp profile illustrated on the outer raceway 26 of the stator 12 may also be useful in minimizing the loss of lubricant support effect of ½ speed load vector rotation.

It should be appreciated that the ovalized and offset ramp profiles of the inner and outer raceways 28, 30 are just two examples of non-circular/non-uniform profiles, and other profiles can also be utilized on either the inner or outer raceways 28, 30 without departing from the subject disclosure. Thus, the foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lubricant supported electric motor comprising:
a stator presenting an outer raceway;
a rotor extending along an axis and rotatably disposed within said stator to present an inner raceway disposed in spaced relationship with said outer raceway to define a gap therebetween;
a lubricant disposed in said gap for supporting said rotor within said stator, and
at least one of said outer raceway or said inner raceway being profiled with a non-circular, cross-sectional shape for maintaining consistent support of said rotor over a wide range of operating speeds and dynamic situations encountered by the lubricant supported electric motor during operation.

2. The lubricant supported electric motor as set forth in claim 1, wherein said outer raceway of said stator includes said non-circular, cross-sectional profile.

3. The lubricant supported electric motor as set forth in claim 2, wherein said outer raceway of said stator having an ovalized cross-sectional profile.

4. The lubricant supported electric motor as set forth in claim 2, wherein said outer raceway of said stator having an offset ramp cross-sectional profile.

5. The lubricant supported electric motor as set forth in claim 4, wherein said outer raceway of said stator includes a semi-circular top portion and a semi-circular bottom portion arranged opposite to one another about a plane extending along the axis, and wherein each of said semi-circular top and bottom portions extend clockwise about the axis from a first end to a second end, with said top and bottom portions each being ramped radially inwards from said first end to said second end.

6. The lubricant supported electric motor as set forth in claim 1, wherein said inner raceway of said rotor includes said non-circular, cross-sectional profile.

7. The lubricant supported electric motor as set forth in claim 6, wherein said inner raceway of said rotor having an ovalized cross-sectional profile.

8. The lubricant supported electric motor as set forth in claim 1, wherein said rotor is operably connected to a final drive device that is interconnected to a wheel of a vehicle.
